(19) United States
(12) Patent Application Publication
(10) Pub. No.: US 2017/0324946 A1
(43) Pub. Date: Nov. 9, 2017

(54) METHOD FOR SCANNING OBJECT HAVING DEPTHS AND SYSTEM THEREOF

(71) Applicant: Microtek International Inc., Hsinchu (TW)

(72) Inventor: Kuo-Huei YU, Hsinchu (TW)

(21) Appl. No.: 15/497,733

(22) Filed: Apr. 26, 2017

(30) Foreign Application Priority Data
May 4, 2016 (TW) 105113883

(51) Int. Cl. H04N 13/02

(52) U.S. Cl. CPC H04N 13/0253; H04N 13/0296; H04N 13/0221; H04N 13/0228

(57) ABSTRACT

A method for scanning an object having depths is provided, using a plurality of rod lenses to limit the blurring range of a contour image of an object having depths to enable an image capture unit to capture an identifiable contour image, wherein either of the diameter of each rod lens and the spacing between the rod lenses is smaller than the average width of the target. A scanning system for scanning an object having depths is also disclosed herein.

### BACKGROUND OF THE INVENTION

### 1. Field of the Invention

The present invention relates to a method for scanning an object and a system thereof, particularly to a method for scanning an object having depths and a system thereof.

### 2. Description of the Prior Art

Refer to FIG. 1. An object A includes a plurality of targets A1, A2, and A3 having depths. In order to scan the object A including the targets A1, A2, and A3 and obtain the contour image thereof, the traditional technology normally uses a sing lens T having a large area and a long depth of field (DOF) to form an image on a charge coupled device (CCD), whereby is acquired the sharp image of the targets A1, A2 and A3 within the DOF thereof.

However, the large-area lens T is likely to bring about some optical defects. For example, the single lens T converges the imaging lights L1 and L2, which are generated by the side face of the target A1 and respectively have different depths, and generate an unsharp image hard to clearly present the contour of the target A1. The unsharpness of an image is particularly likely to take place in the imaging lights L1 and L2 having larger incident angles because the imaging lights L1 and L2 have a larger optical path difference. The direction and size of the unsharp area of an image, which is caused by the depth of the target, varies with the incident angle and the distance between the target and the center of the lens. Besides, a single lens needs complicated optical design, which makes the scanning system bulky and expensive.

Therefore, a slim and compact system for scanning an object having depths and the method thereof is a target that the industry is eager to achieve.

### SUMMARY OF THE INVENTION

The present invention provides a method for scanning an object having depths and a system thereof, wherein a plurality of rod lenses is used to restrict the unsharp range of the image of an object having depths and enable an image capture unit to capture an identifiable contour image of the object, and wherein the diameter of each rod lens is preferably smaller than the minimum width of each target.

One embodiment of the present invention proposes a method for scanning an object having depths, which comprises steps: using a light source to illuminate an object to generate a plurality of imaging lights respectively having different depths of field, wherein the object includes a target having a depth; using a plurality of rod lenses to receive the plurality of imaging lights respectively from the visible regions of the rod lenses and output a plurality of localized imaging lights to the imaged areas, wherein either of the diameter of each rod lens and the spacing between the rod lenses is smaller than the minimum width of the target, and wherein the imaged areas are identical in size; and using an image capture unit to capture the plurality of localized imaging lights to form a corresponding contour image.

Another embodiment of the present invention proposes a system for scanning an object having depths, which comprises a light source, a plurality of rod lenses, and an image capture unit. The light source illuminates an object to generate a plurality of imaging lights respectively having different depths of field. The object includes a target having a depth. The plurality of rod lenses is disposed side by side with the optical axes thereof parallel to each other. The plurality of rod lenses receives the plurality of imaging lights from the visible regions of the rod lenses and outputs a plurality of localized imaging lights to a plurality of imaged areas. Either of the diameter of each rod lens and the spacing between the rod lenses is smaller than the average width of the contour of the target. The imaged areas are identical in size. The image capture unit is disposed at the light output sides of the plurality of rod lenses, capturing the plurality of localized imaging lights to form a contour image of the object.

Below, embodiments are described in detail in cooperation with the attached drawings to make easily understood the objectives, technical contents, characteristics and accomplishments of the present invention.

### BRIEF DESCRIPTION OF THE DRAWINGS

FIG. 1 is a diagram schematically showing a conventional image scanning system using a single lens;

FIG. 2 is a diagram schematically showing a system for scanning an object having depths according to one embodiment of the present invention;

FIG. 3 is a diagram schematically showing a system for scanning an object having depths according to another embodiment of the present invention; and

FIG. 4 is a flowchart of a method for scanning an object having depths according to one embodiment of the present invention.

### DESCRIPTION OF THE PREFERRED EMBODIMENTS

The present invention will be described in detail with embodiments and attached drawings below. However, these embodiments are only to exemplify the present invention but not to limit the scope of the present invention. In addition to the embodiments described in the specification, the present invention also applies to other embodiments. Further, any modification, variation, or substitution, which can be easily made by the persons skilled in that art according to the embodiment of the present invention, is to be also included within the scope of the present invention, which is based on the claims stated below. Although many special details are provided herein to make the readers more fully understand the present invention, the present invention can still be practiced under a condition that these special details are partially or completely omitted. Besides, the elements or steps, which are well known by the persons skilled in the art, are not described herein lest the present invention be limited unnecessarily. Similar or identical elements are denoted with similar or identical symbols in the drawings. It should be noted: the drawings are only to depict the present invention schematically but not to show the real dimensions or quantities of the present invention. Besides, matterless details are not necessarily depicted in the drawings to achieve conciseness of the drawings.

Refer to FIG. 2 a diagram schematically showing a system for scanning an object having depths according to one embodiment of the present invention. The system of the present invention comprises a light source 10, a plurality of rod lenses 20, and an image capture unit 30. The light source 10 illuminates an object A to generate a plurality of imaging lights L1 and L2 respectively having different depths of field. The object A is semi-transparent and has a specified thickness. The object A includes a target A1 having a depth. In one embodiment, the light source 10 is a fluorescent tube lamp, a light-emitting diode, or an exciting light source. However, the present invention is not limited by the abovementioned embodiment. In one embodiment, the exciting light source 10 excites the fluorescent material in the target A1 to generate a fluorescent image.

Refer to FIG. 2 again. The plurality of rod lenses 20 is disposed side by side with the optical axes thereof parallel to each other. Each rod lens 20 receives the imaging lights L1 and L2 from a visible region B of the rod lens 20 and outputs localized imaging lights L3 and L4 to an imaged area P. Either of the diameter D of each rod lens 20 and the spacing C between the rod lenses 20 is smaller than the minimum width E of the target A1. In one embodiment, either of the diameter D of each rod lens 20 and the spacing C between the rod lenses 20 is further smaller than the depth of the target A1. In one embodiment, the aperture of each rod lens 20 is smaller than 1.1 mm. For example, the visible angle of each rod lens 20 with respect to the visible region B is 24 degrees. Therefore, the rod lens 20 is only allowed to receive the imaging lights L1 and L2 whose incident angles are 12 degrees at maximum. In one embodiment, the aperture of each rod lens 20 is 0.6 mm.

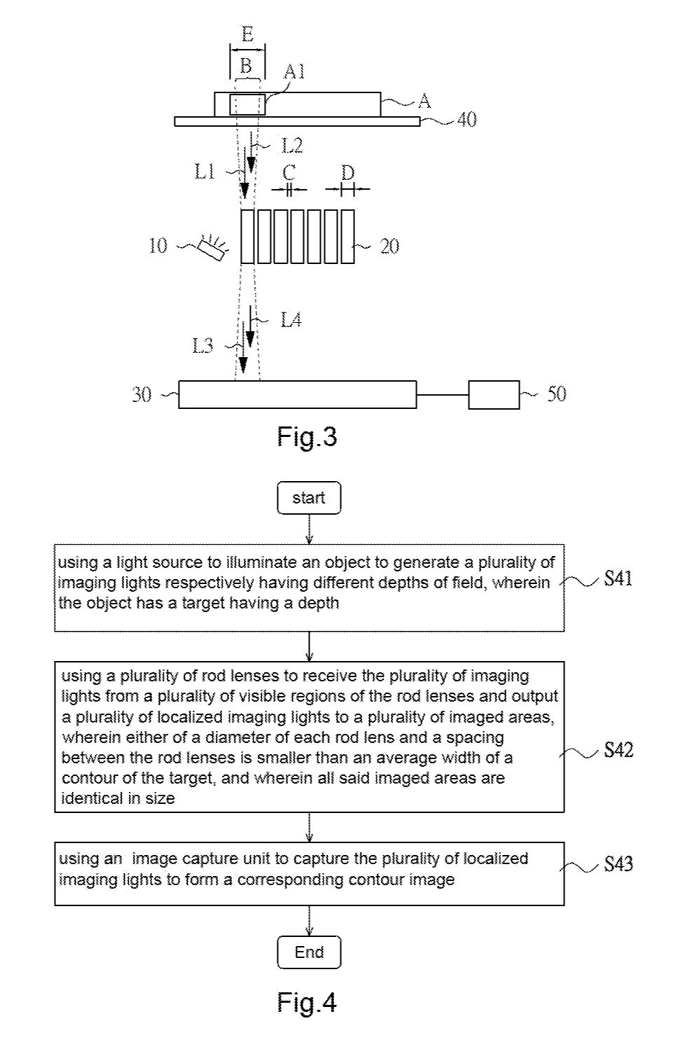

Refer to FIG. 2 and FIG. 3. The image capture unit 30 is disposed at the light output side of the rod lenses 20, capturing a plurality of localized imaging lights L3 and L4 to form a corresponding contour image. In one embodiment, the system for scanning an object having depths further comprises a platform 40. The platform 40 includes a light-permeable material, and the object A is placed on the platform 40. The light source 10 illuminates the object A to generate a plurality of imaging lights L1 and L2 respectively having different depths of field. In one embodiment, the system for scanning an object having depths of the present invention further comprises a driving unit 50, which drives the image capture unit 30 and the object A to move with respect to each other to scan the object A. For an example, the driving unit 50 is coupled to the platform 40 and drives the platform 40 carrying the object A to move with respect to the image capture unit 30. For another example, the driving unit 50 is coupled to the image capture unit 30 (and rod lenses 20) and drives the image capture unit 30 and (and rod lenses 20) to scan the object A. In one embodiment, the image capture unit 30 is a contact type image capture unit; the driving unit 50 further comprises a linkage assembly (not shown in the drawings) coupled to the image capture unit 30. In a preferred embodiment, the scanning light source 10 is coupled to the linkage assembly and synchronized with the image capture unit 30 to scan the object A having a fluorescent material so as to obtain high-brightness and high-contrast scan images. The persons with ordinary knowledge in the field should be able to modify or vary the abovementioned embodiments with departing from the spirit of the present invention.

The rod lenses used by the present invention only occupy a small space. Therefore, the present invention uses the rod lenses and an image capture unit to form a slim and compact system for scanning an object having depths without using the bulky single lens and charge coupled device.

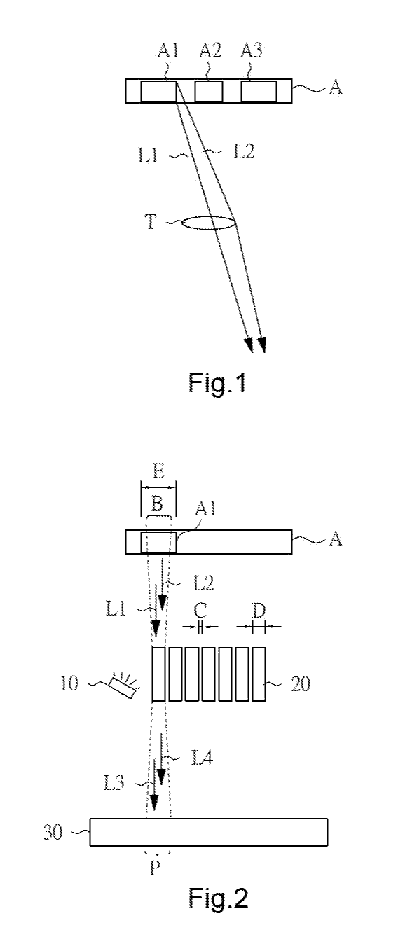

Below is described the principle of a method and system for scanning an object having depths according to one embodiment of the present invention. Refer to FIG. 1. The object A includes a plurality of targets A1, A2 and A3. The traditional scanning technology normally uses a large-area single lens to form an image on a charge coupled device (CCD). However, a plurality of imaging lights L1 and L2 respectively having different depths of field will be converged by the single lens onto the charge coupled device jointly. The larger the incident angle of the imaging light, the more blurred the defocused image. In other words, the traditional image scanning system uses a single lens to receive the imaging lights of all the targets A1, A2 and A3 and converges all the imaging lights onto a single blurred area where the imaging lights interference with each other. The farther the imaging light deviates from the center of the single lens, the more serious the blurred phenomenon. Thus, it is hard to distinguish the lines, contours and patterns of the targets A1, A2 and A3 in the generated contour image. In other words, the direction and size of the blurred area of the image, which is caused by the depth of the target, varies with the incident angle and the distance between the target and the center of the single lens.

In one embodiment, the method and system for scanning an object having depths adopts rod lenses having shallow depth of field (DOF). Although the shallow-DOF rod lenses make blurred the deep images, which are far beyond the DOF of the shallow-DOF rod lenses, the blurring generated by each rod lens is restricted to a smaller region of the imaged area because the plurality of rod lenses is disposed side by side with the optical axes thereof parallel to each other. Besides, the imaged areas of the rod lenses are identical in size. Therefore, the scanning method of the present invention can still generate an identifiable contour image in comparison with the conventional scanning method using a single lens. The principle of the present invention is to be described in further detail below.

Refer to FIG. 2 again. Each of the plurality of rod lenses 20, which are disposed side by side with the optical axes thereof parallel to each other, only receives the imaging lights L1 and L2 from the visible region B of the rod lens 20 and outputs the localized imaging lights L3 and L4 to an imaged area P. In other words, a single rod lens 20 does not receive all the imaging lights, which are generated by all the targets A1, A2, and A3 and respectively may have different DOF's. It is the array of all the rod lenses 20 that can receive all the imaging lights and output the localized imaging lights to all the imaged areas. Therefore, the imaging lights L3 and L4 output by each rod lens 20 are localized. Even though the contour image generated by the localized imaging lights is blurred, the blurring is only limited to a small region of an imaged area P. Besides, all the imaged areas P are identical in size. Even though one imaged area P generated by the imaging lights is completely blurred, the blurring is only restricted to the single imaged area P. The contour of the targets can still be presented by the colors and gray levels of the plurality of imaged areas.

It should be noted: not all the conventional rod lenses can be used to achieve the effect of the present invention. The rod lens 20 that can be used by the present invention must meet the following condition: either of the diameter D of each rod lens 20 and the spacing C between the rod lenses 20 is smaller than the average width E of the target A1. A single rod lens 20 cannot receive all the imaging lights of even a single target A1 but can only receive a portion of the imaging lights of the target A1. The plurality of imaged areas P receives the localized imaging lights of a single target A1 and fully presents the contour image of the single target A1. It is easily understood: for an identical target A1, the localized imaging lights generated by 10 pieces of rod lenses and the localized imaging lights generated by 50 pieces of rod lenses will respectively result in different extents of blurring in the contour image; the contour image generated by 50 pieces of rod lenses should be more clear than that generated by 10 pieces of rod lenses. In other words, the smaller the diameter D of the rod lenses 20 with respect to the minimum width E of the target A1 (assume identical view angle), the higher the ability of the rod lenses 20 to improve the blurring of the contour image. Therefore, the assembly of rod lenses can effectively improve the blurring caused by the shallow DOF of the rod lenses. The present invention is not limited by the abovementioned embodiments. The persons skilled in the art should be able to modify or vary the abovementioned embodiments without departing from the spirit of the present invention.

Below is described a method for scanning an object having depths according to one embodiment of the present invention. Refer to FIG. 1 and FIG. 4. The method of the present invention comprises Steps S41-S43. In Step S41, use a light source 10 to illuminate an object A to generate a plurality of imaging lights L1 and L2 respectively having different depths of field, wherein the object A includes targets A1, A2 and A3. In one embodiment, the step of using the light source 10 to illuminate the object A includes using an exciting light source 10 to illuminate the object A so as to excite the fluorescent material in the object A and generate fluorescent images. The technology or embodiments thereof have been described in detail hereinbefore and will not repeat herein.

Next, in Step S42, use a plurality of rod lenses 20 to receive a plurality of imaging lights L1 and L2 from a plurality of visible regions B and output a plurality of localized imaging lights ′L3 and L4, wherein the plurality of rod lenses 20 is disposed side by side with the optical axes thereof parallel to each other, and wherein either of the diameter D of each rod lens 20 and the spacing C between the rod lenses 20 is smaller than the minimum width E of the target A1. In one embodiment, either of the diameter D of each rod lens 20 and the spacing C between the rod lenses 20 is smaller than the depth of the target A1. The technology or embodiments thereof have been described in detail hereinbefore and will not repeat herein.

Then, in Step S43, use an image capture unit 30 to capture the plurality of localized imaging lights ′L3 and L4 to form a corresponding contour image. In one embodiment, the method for scanning an object having depths of the present invention further comprises a step of providing a platform 40, which includes a light-permeable material, wherein the object A is placed on the platform 40, and wherein the light source 10 illuminates the object A to generate a plurality of imaging lights L1 and L2 respectively having different depths of field. In one embodiment, the system for scanning an object having depths further comprises a step of using a driving unit 50 to drive the image capture unit 30 and the object A to move with respect to each other to scan the object A. The technology or embodiments thereof have been described in detail hereinbefore and will not repeat herein.

In conclusion, the present invention proposes a method and system for scanning an object having depths, which is characterized in using a plurality of rod lenses to restrict the blurred regions of the imaged areas and form an identifiable contour image, wherein all the imaged areas are identical in size. In a preferred embodiment, the diameter of each rod lens is smaller than the average width of the target. The rod lenses occupies a smaller space, able to realize a slim and compact system for scanning an object having depths in cooperation with an image capture unit without using the bulky single lens and charge coupled device.

What is claimed is:

1. A method for scanning an object having depths, comprising steps:
using a light source to illuminate an object to generate a plurality of imaging lights respectively having different depths of field, wherein said object has a target having a depth;
using a plurality of rod lenses to receive the plurality of said imaging lights from a plurality of visible regions of said rod lenses and output a plurality of localized imaging lights to a plurality of imaged areas, wherein either of a diameter of said rod lens and a spacing between said rod lenses is smaller than an average width of a contour of said target, and wherein all said imaged areas are identical in size; and
using an image capture unit to capture the plurality of said localized imaging lights to form a corresponding contour image.

2. The method for scanning an object having depths according to claim 1, wherein either of said diameter of said rod lens and said spacing between said rod lenses is smaller than said depth of said target.

3. The method for scanning an object having depths according to claim 1, wherein an aperture of said rod lens is smaller than 1.1 mm.

4. The method for scanning an object having depths according to claim 1, wherein said step of using a light source to illuminate an object includes a step of using an exciting light source to illuminate said object and excite a fluorescent material in said object.

5. The method for scanning an object having depths according to claim 1 further comprising a step of
providing a platform including a light-permeable material, wherein said object is placed on said platform.

6. The method for scanning an object having depths according to claim 1 further comprising a step of
using a driving unit to drive said image capture unit and said object to move with respect to each other to scan said object.

7. A system for scanning an object having depths comprising
a light source used to illuminate an object to generate a plurality of imaging lights respectively having different depths of field, wherein said object has a target having a depth;
a plurality of rod lenses disposed side by side with optical axes thereof parallel to each other, used to receive the plurality of said imaging lights from a plurality of visible regions of said rod lenses and output a plurality of localized imaging lights, wherein either of a diameter of said rod lens and a spacing between said rod lenses is smaller than an average width of a contour of said target, and wherein blurred ranges of said localized imaging lights are identical in size; and
an image capture unit disposed at a light output side of the plurality of said rod lenses to capture the plurality of said localized imaging lights to form a corresponding contour image.

8. The system for scanning an object having depths according to claim 7, wherein either of said diameter of said rod lens and said spacing between said rod lenses is smaller than said depth of said target.

9. The system for scanning an object having depths according to claim 7, wherein an aperture of said rod lens is smaller than 1.1 mm.

10. The system for scanning an object having depths according to claim 7, wherein said light source includes an exciting light source used to illuminate said object and excite a fluorescent material in said object.

11. The system for scanning an object having depths according to claim 7 further comprising
a platform including a light-permeable material, wherein said object is placed on said platform.

12. The system for scanning an object having depths according to claim 7 further comprising
a driving unit used to drive said image capture unit and said object to move with respect to each other to scan said object.
